(19) United States
(12) Patent Application Publication
(10) Pub. No.: US 2004/0191752 A1
(43) Pub. Date: Sep. 30, 2004

(54) Continuing professional education management system

(76) Inventor: William R. Fry, Colorado Springs, CO (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/813,984

(22) Filed: Mar. 31, 2004

Related U.S. Application Data
(60) Provisional application No. 60/459,052, filed on Mar. 31, 2003.

(51) Int. Cl. G09B 25/00; G09B 3/00

(52) U.S. Cl. 434/365

(57) ABSTRACT

An Internet-based subscription service for professionals provides a convenient, reliable and efficient means of maintaining continuing professional education (CPE) information. The information may concern various types of continuing professional education, including continuing medical education, nursing education, legal education, engineering education, military education, and so forth. In the preferred embodiment, the CPE management system provides the user with a subscription service that can be obtained through various conventional channels for conducting interactive registration, depositing information, and collecting subscription service fees. Preferably, the subscription service is provided over the Internet whereby a user may access his or her CPE documentation via any conventional computer terminal connected thereto. However, in alternative embodiments, the system may also be maintained and facilitated by other methods that illustratively includes the internet, LAN, WAN and/or via mailings.

### REFERENCE TO RELATED APPLICATION

This application claims priority from U.S. Provisional Patent Application Serial No. 60/459,052, filed Mar. 31, 2003, the entire content of which is incorporated herein by reference.

### FIELD OF THE INVENTION

The present invention relates to a method and system for managing information, and more particularly to the management of information associated with continuing professional education training documentation.

### BACKGROUND OF THE INVENTION

Continuing education/professional development is the means by which professionals such as physicians, attorneys, and engineers fulfill academic obligations to themselves, their clients, their professional colleagues and the public. It gives such individuals the means to obtain the latest information and develop the skills to ensure that they offer clients up-to-date, efficient and effective advice and/or professional services, and meet all regulatory requirements and standards.

Typically, providers of accredited training programs are required to provide participants with some form of verification (e.g. certificate, relicensure or diploma) of the participant's attendance and completion of each program in order for the professional individuals to receive recognition for the continuing education credits that they have acquired.

For the busy professional, maintaining records of continuing professional education (CPE) attendance and completion can become a time consuming and burdensome task which requires the professional to set aside valuable time from his or her practice to organize and store these training records in a place where they would be readily available when needed.

Some of the factors related to the difficulties in organizing and maintaining these records include misplacing, not receiving or not applying for the CPE documentation that proves that the individual attended a particular course; the inability of the professional to keep a running tabulation of the accumulated CPE credits for extended periods of time; and/or having no central place to act as a repository for the CPE documentation that can be readily accessed and obtained for sending the documentation on to regulatory agencies or others for the purpose of obtaining relicensure, hospital job appointments and/or trauma site verification.

Many regulatory agencies sometimes not only require proof of attendance but in some cases a description of the course content as well as some form of participant evaluation (e.g. exams) to ensure that the participant was able to comprehend and/or retain the concepts of the course. Accordingly, maintaining this information in an organized form where it can be readily accessed and distributed to regulatory and/or accrediting agencies will provide a benefit to many professionals who seek to maintain proof of their continuing professional education in such a manner.

### SUMMARY OF THE INVENTION

This invention improves upon existing methods by providing an Internet-based subscription service for professionals that desire to have a convenient, reliable and efficient means of maintaining continuing professional education (CPE) information. The method includes the steps of establishing a service provider website accessible via a communications network, providing a database for storing information related to continuing education activities performed by a subscriber, and forwarding the information to at least one entity upon receiving authorization to do so from the subscriber. The information may concern various types of continuing professional education, including continuing medical education, nursing education, legal education, engineering education, military education, and so forth.

In the preferred embodiment, the CPE management system provides the user with a subscription service that can be obtained through various conventional channels for conducting interactive registration, depositing information, and collecting subscription service fees. Preferably, the subscription service is provided over the Internet whereby a user may access his or her CPE documentation via any conventional computer terminal connected thereto. However, in alternative embodiments, the system may also be maintained and facilitated by other methods that illustratively includes the intranet, LAN, WAN and/or via mailings.

### DETAILED DESCRIPTION OF THE INVENTION

The present invention improves upon existing methods by providing an Internet-based subscription service for professionals that desire to have a convenient, reliable and efficient means of maintaining CPE documentation for extended periods of time.

In the preferred embodiment, the CPE management system provides the user with a subscription service that can be obtained through various conventional channels for conducting interactive registration, depositing information, and collecting subscription service fees. Preferably, the subscription service is provided over the Internet whereby a user may access his or her CPE documentation via any conventional computer terminal connected thereto. However, in alternative embodiments, the system may also be maintained and facilitated by other methods that illustratively includes the intranet, LAN, WAN and/or via mailings.

Fees for the subscription services may be based on several criteria which may illustratively include the user's profession, hourly usage, monthly usage, semi-annual or annual usage. Subscription services could be set up for a single individual, a corporation, professional associations/organizations or CPE providers that desire to offer this service to its clients.

Once a user has obtained a subscription to the continuing professional education management system, the professional is able to access and send the CPE documentation or other information to the management system service provider repository for storing and keeping track of the CPE data.

For each user an electronic record would be created and maintained in a repository or central database and made accessible over the communications network. It will be appreciated that the information can also be sent to the repository service provider via conventional means such as mailing, faxing or telecommunication system providing the information can be accurately and reliably communicated to the service provider for entry into the client database.

The type of information to be stored within the service provider's database may vary from client to client. Client information maintained may illustratively include course certificates, diplomas, training schedules, tabulation of credits, course outlines, training verification and participant evaluation reports. Also, information relative to the participant's professional specialty, type of CPE credit needed, reporting dates and times required by the state and local and/or other regulatory agencies, preferences for the date and times where the training would take place, and personal identification information of the professional participant.

By utilizing information maintained in the client's electronic record, reminders could be sent to the client about the need for further CPE to meet their individual requirements. The service provider may send the client e-mails that include links to upcoming continuing education courses, seminars, conferences or conventions that may be of interest to the client toward obtaining future CPE credit.

The CPE management system may also be a benefit to associations, organizations or groups that sponsor CPE programs for various professionals as an optional service to its clients. The association or sponsoring group may add a charge to a participant's registration fee to cover the cost of using the subscription service. Each participant's documentation received for attending and completing a conference or seminar could be directly deposited into the service provider's database by the sponsoring group such that the participant is relieved from having to perform the task.

The subscription service provider may receive a portion of the registration fee from the CPE provider for allowing them to advertise in its brochure and/or during the CPE training courses or seminars. Additional fees may be charged for the ability to receive advertising about an upcoming conference or seminar being offered by the CPE provider or the CPE provider may elect to place an advertisement on the service provider's website or the service provider's mailings.

Software is provided to the CPE provider to record the necessary data points to be sent to the subscription service for each program participant. Detailed information about the conference would also accompany this documentation, which illustratively includes information about the conference hours, number of attendees, credit hours earned by each participant, and course content. This data would then be put into the individual participant's electronic record maintained in the service provider database. It is appreciated that each user will be provided some sort of access authorization that may be in the form of a pin number, password, member number or the like.

When a CPE management system client needs a copy of his or her electronic record, they would send a request to the subscription service provider to forward a copy of their record to whomever they wanted the information sent, such as a regulatory agency, professional organization or accrediting body. Users may be limited in the amount of record distributions that they are allowed to send during a subscription period such that the cost of providing the service does not exceed the financial benefit realized by the service provider.

By using the personal authorization code provided, each participant will be able to log into the service provider website where an encrypted entry portal would be encountered to prevent unauthorized and/or fraudulent use. The subscriber would then be able to check their electronic record to ensure its accuracy and/or in query for determining how many additional CPE credits are needed to satisfy a present CPE requirement.

If a participant attends a conference or seminar hosted by a CPE provider that is not signed up with the CPE management system, then the participant will be responsible for forwarding the CPE documentation on to the service provider for input into his or her electronic record.

Preferably, clients are not allowed to enter their own CPE data into their electronic record under normal protocol as a means of preventing or discouraging the entry of fraudulent data by an unscrupulous client. However, a client may be allowed to enter certain details about a particular seminar or conference attended which will be required to be subsequently validated by a representative of the CPE provider indicating that the client had in fact participated in the event and is entitled to credit. Alternatively, the service provider may also provide a service of verifying that the data submitted by a client is accurate by contacting the CPE provider as an alternative means of addressing this issue. It will be appreciated that a service provider client would have to authorize the service provider to conduct such an inquiry such that privacy violations would be obviated.

From the foregoing, the present invention provides a web-based subscription service whereby various professionals such as physicians, lawyers, nurses, engineers or the like may maintain their CPE documentation for extended periods of time wherein the information can be conveniently and readily accessed for the professional's review and authorization may be given for forwarding the information on to various regulatory or accrediting agencies upon the professional's request.

I claim:

1. A method of managing continuing education data, comprising the steps of:
establishing a service provider website accessible via a communications network;
providing a database for storing information related to continuing education activities performed by a subscriber; and
forwarding the information to at least one entity upon receiving authorization to do so from the subscriber.

2. The method of claim 1, wherein the information concerns continuing medical education.

3. The method of claim 1, wherein the information concerns continuing nursing education.

4. The method of claim 1, wherein the information concerns continuing legal education.

5. The method of claim 1, wherein the information concerns continuing engineering education.

6. The method of claim 1, wherein the information concerns continuing military education.
